(19) United States
(12) Patent Application Publication
(10) Pub. No.: US 2010/0033621 A1
(43) Pub. Date: Feb. 11, 2010

(54) VIDEO SYSTEM AND MEMORY SHARING METHOD

(75) Inventors: Jia-Han CHANG, Taipei City (TW); Chung-Yen LU, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/186,740

(22) Filed: Aug. 6, 2008

(51) Int. Cl. H04N 7/01; H04N 5/14; H04N 3/27; H04N 5/45

(52) U.S. Cl. 348/446; 348/571; 348/554; 348/565; 348/E05.062; 348/E07.001; 348/E03.049; 348/E05.112

(57) ABSTRACT

A memory sharing method provided, comprising determining a type of an input video signal, sharing an SRAM (static random access memory) pool among at least two different processing units of the video system, wherein the SRAM pool comprises a plurality of SRAM units having different sizes, and an SRAM unit size is determined as a common factor of memory sizes required by at least two processing units, and allocating a combination of SRAM units in the SRAM pool to each processing unit processing the input video signal according to the type of the input video signal.

### BACKGROUND OF THE INVENTION

1. Field of the Invention

The invention relates to a video system, and in particular relates to a plurality of processing units in the video system sharing memory.

2. Description of the Related Art

A video system is designed to be capable of receiving and processing video signals complying with different standards, such as an S-video (separate video) signal, an HDMI (high definition multimedia interface) signal, an AV (composite video) signal, a turner signal, a DVI (digital visual interface) signal, an HDTV (high definition television) signal and a VGA (video graphics array) signal, and display corresponding images on a display panel. However, different signals are not processed in the same way by the video system, for example, some of the mentioned signals require comb filtering and deinterlacing, some only requires deinterlacing, and some other signals are processed without comb filtering and deinterlacing. Furthermore, the size of the display panel also influences the video processing operation of the input signal, for example, the signal are scaled down or scaled up based on the display dimension.

### BRIEF SUMMARY OF THE INVENTION

A detailed description is given in the following embodiments with reference to the accompanying drawings.

An embodiment of a memory sharing method for a video system is provided. The method comprises determining a type of an input video signal, sharing an SRAM (static random access memory) pool among at least two different processing units of the video system, wherein the SRAM pool comprises a plurality of SRAM units having different sizes, and an SRAM unit size is determined as a common factor of memory sizes required by at least two processing units, and allocating a combination of SRAM units in the SRAM pool to each processing unit processing the input video signal according to the type of the input video signal.

Another embodiment of a video system is provided. The video system comprises a plurality of processing units, an SRAM pool and a controller. The SRAM pool comprises a plurality of SRAM units having different sizes for sharing among at least two different processing units, wherein an SRAM unit size is determined as a common factor of memory sizes required by at least two processing units. The controller determines a type of an input video signal, and allocates a combination of SRAM units to each processing unit processing the input video signal according to the type of the input video signal.

Another embodiment of a video system is provided. The video system comprises a main source selection unit, a sub source selection unit, a plurality of processing units, an SRAM pool, a controller, and a mixer. The main source selection unit receives and selects input video signals for a main path. The sub source selection unit receives and selects input video signals for a sub path. The set of the processing units processes the input video signal of the main path, and another set processes the input video signal of the sub path. The SRAM pool comprises a plurality of SRAM units having different sizes for sharing among at least two different processing units. An SRAM unit size is determined as a common factor of memory sizes required by at least two processing units. The controller determines a type of the input video signal selected by the main source selection unit and the sub source selection unit, and allocates a combination of SRAM units to each processing unit processing the input video signal of the main path or sub path according to the type of the input video signal processed in the main path or sub path. The mixer blends processed main video signal and processed sub video signal for output display.

### BRIEF DESCRIPTION OF THE DRAWINGS

The invention can be more fully understood by reading the subsequent detailed description and examples with references made to the accompanying drawings, wherein:

FIG. 1 shows a video system 100 with dedicated SRAM units for each processing unit.

FIG. 2 shows a video system with an SRAM pool according to an embodiment of the invention.

### DETAILED DESCRIPTION OF THE INVENTION

The following description includes the best-contemplated mode of carrying out the invention. This description is made for the purpose of illustrating the general principles of the invention and should not be taken in a limiting sense. The scope of the invention is best determined by reference to the appended claims.

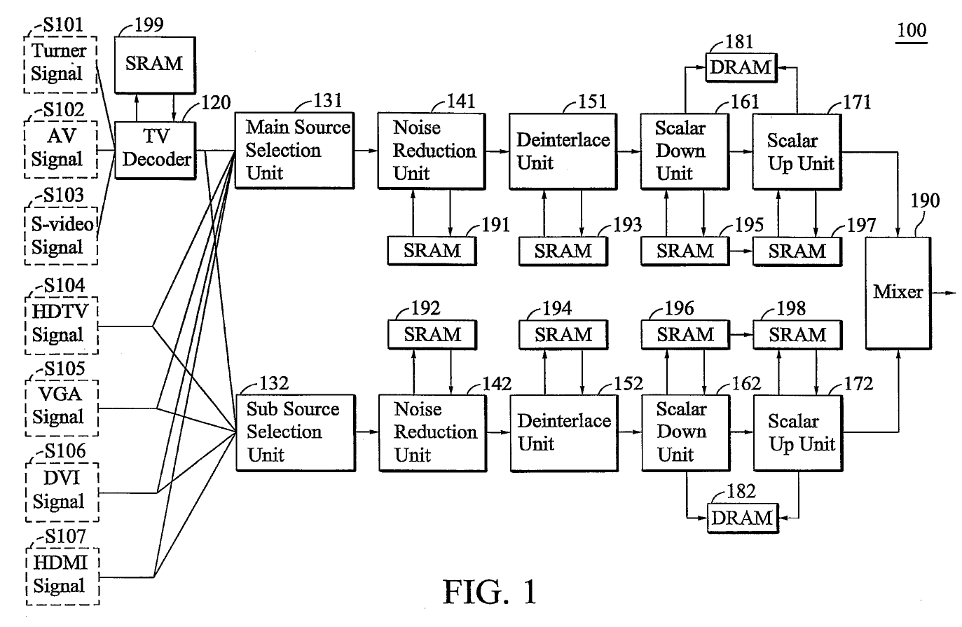

FIG. 1 shows a video system 100 with dedicated SRAMs for post-processing units. The video system 100 is capable of mixing two video sources, and it comprises a TV decoder 120, a main source selection unit 131, a sub-source selection unit 132, SRAM units 191˜199, a mixer 290, DRAM units 181 and 182, and a plurality of post-processing units. The video system 100 can be divided into two parts, a main source part and a sub-source part for processing the main video input and sub video input in parallel. The main source part comprises a main source selection unit 131, a noise reduction unit 141, a deinterlace unit 151, a scalar down unit 161, a scalar up unit 171, SRAM units 191, 193, 195, and 197 and a DRAM unit 181. The sub-source part comprises a sub-source selection unit 132, a noise reduction unit 142, a deinterlace unit 152, a scalar down unit 162, a scalar up unit 172, SRAM units 192, 194, 196 and 198, and a DRAM unit 182.

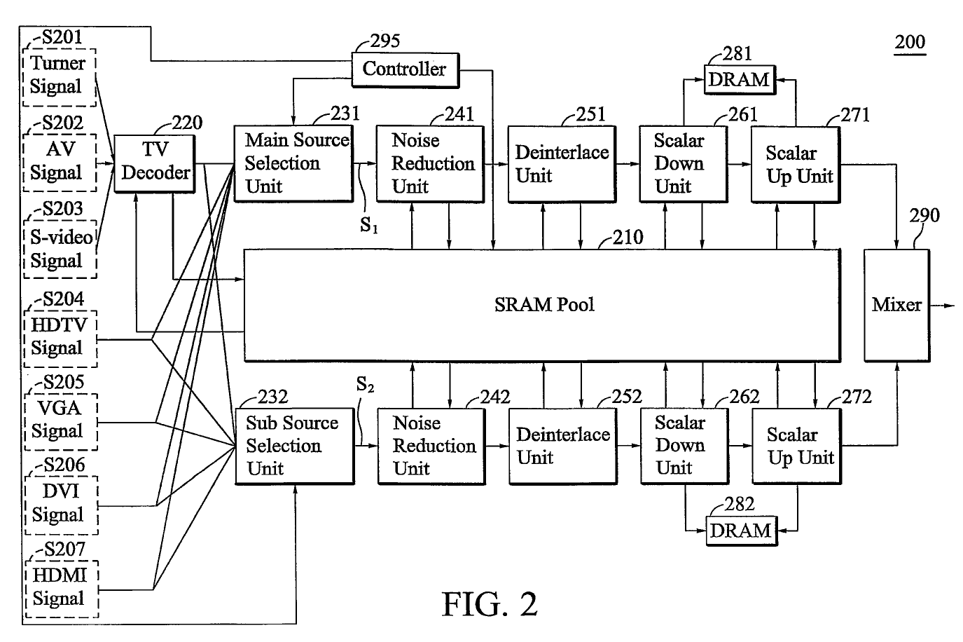

FIG. 2 shows a video system 200 with an SRAM pool 210 according to an embodiment of the invention. The video system 200 comprises a TV decoder 220, a main source selection unit 231, a sub-source selection unit 232, an SRAM pool 210, a controller 295, post-processing units, DRAM units 281 and 282, a mixer 290, and a display panel (not shown in FIG. 2). In some other embodiments, DRAM units are not necessary for scaling up or down as data can be stored in the SRAM pool 210 or registers. The main source selection unit 231, the sub-source selection unit 232, the SRAM pool 210, the controller 295, processing units, and the mixer 290 may be allocated in a single image decoding chip. The signal processing is divided into two paths, a main source path and a sub-source path, where the sub-source path is typically active when the picture in picture (PIP) function is enabled. The main source path for a main video input comprises decoding by a TV decoder 220 if the main video input is a tuner, AV, or Svideo signal, selecting by a main source selection unit 231, and post processing by at least one of a noise reduction unit 241, a deinterlace unit 251, a scalar down unit 261, and a scalar up unit 271. The sub-source path for a sub video input comprises decoding by a TV decoder 220 if the sub video input is a tuner, AV, or Svideo signal, selecting by a sub-source selection unit 232, and post processing by at least one of a noise reduction unit 242, a deinterlace unit 252, a scalar down unit 262, and a scalar up unit 272.

The video system 200 is capable of processing different kinds of image signals, such as a tuner signal S201 received by a tuner, an AV signal S202 received through a composite video connector, an S-video signal S203, an HDTV signal S204, a VGA signal S205, a DVI signal S206 and an HDMI signal S207 for displaying images on the display panel. However, the invention is not limited to the mentioned image signals, and it is also not limited to the number of types of image signals supported by the video system.

The TV decoder unit 220 is for decoding the tuner signal S201, AV signal S202 or S-video signal S203 to output the decoded signal to the main source selection unit 231 and/or the sub-source selection unit 232. In this embodiment, the main source selection unit 231 and the sub-source selection unit 232 act like a multiplexer for selecting an output from the decoded tuner signal, decoded AV signal, decoded S-video signal, HDTV signal S204, VGA signal S205, DVI signal S206 and HDMI signal S207 according to the controller 295. The main source selection unit 231 and the sub-source selection unit 232 respectively output video signals S1 and S2 to perform post-processing such as noise reduction units 241 and 242 according to a user setting or default setting. The controller 295 detects types of the video signals S1 and S2 to determine sharing of the SRAM among various processing units and allocation of SRAM units among the processing units. The signals S1 and S2 may be the same or different type of image signal. The signal S1 is processed through one or a combination of the noise deduction unit 241, the deinterlace unit 251, the scalar down unit 261 and the scalar up unit 271, and then outputted to the mixer 290. The signal S2 is processed through one or a combination of the noise deduction unit 242, the deinterlace unit 252, the scalar down unit 262 and the scalar up unit 272, and then outputted to the mixer 290. The mixer 290 blends the processed signal S1 and the processed signal S2 when the display mode indicates displaying two signal sources simultaneously, for example, when the display mode belongs to a PIP (picture in picture) or POP (picture of picture) mode, otherwise, the mixer 290 is bypassed. In an embodiment, the maximum size for displaying the processed signal S2 (sub video input) is a quarter of the entire displaying area.

As shown in FIG. 2, the post-processing units, such as noise source selection units 241 and 242, deinterlace units 251 and 252, scalar down units 261 and 262, and scalar up units 271 and 272 share the SRAM pool 210. Since each post-processing unit occupies a variable SRAM size depending on the type of the input video signal and the size of the display panel, the controller 295 allocates various sizes of SRAM units of the SRAM pool 210 among the post-processing units. The SRAM pool 210 is shared by a plurality of post-processing units to reduce the number and total size of SRAM units required by the video system 200. An SRAM pool with ingenious memory allocation scheme is more efficient and cost saving than dedicated SRAM units for each post-processing unit as shown in FIG. 1. The SRAM pool 210 comprises a plurality of SRAM unit with several different memory sizes. The SRAM pool 210, controlled by the controller 295, shares and allocates SRAM units with various sizes among the post-processing units. Therefore, the video system 200 can equipped with less SRAM units and thus reduces the cost and size of the integrated circuit chip.

TABLE 1
(main path)

| | | TV decoder | NR | Deinterlace | Scalar down | Scalar up |
|---|---|---|---|---|---|---|
| Panel 1440 * 768 | | (bits) | (bits) | (bits) | (bits) | (bits) |
| TV | 480i/576i | (Nt2 + Nt3) * 1135 * 10 | Nmn * 720 * 10 | Nmd * 720 * 10 | 0 | Mmsu * 720 * 10 |
| YPbPr | 1080i | 0 | Nmn * 1920 * 10 | Nmd * 1920 * 10 | Nmsd * 1440 * 10 | 0 |
| VGA | 800 * 600 | 0 | Nmn * 800 * 10 | 0 | 0 | Mmsu * 800 * 10 |
| VGA | 1920 * 1200 | 0 | Nmn * 1920 * 10 | 0 | Nmsd * 1440 * 10 | 0 |

Table 1 shows SRAM sizes required for processing different types of main video input through different post-processing stages to be displayed on a display panel with 1440*768 pixels. For example, when the main video input is a 480i/576i video signal received from a TV tuner, the TV decoder 220 requires an SRAM size of (Nt2+Nt3)*1135*10 bits, the noise reduction unit 241 required an SRAM size of Nmn*720*10 bits, the deinterlace unit 251 required an SRAM size of Nmd*720*10 bits, the scalar down unit 261 did not require any SRAM because the image size of the 480i/576i video input signal is smaller than that of the panel resolution (1440*768), and the scalar up unit 271 required an SRAM size of Nmsu*720*10 bits. Nt2 is the number of lines required for a two-dimensional comb filter, Nt3 is the number of lines required for a three-dimensional comb filter, Nmn is the line length required for noise reduction in the main path, Nmd is the line length required for deinterlace, Nmsd is the line length required for scale down, and Nmsu is the line length required for scale up (“m” denotes main path). In this example, the number of bits in a pixel is 10 bits. SRAM sizes required at each stage for processing various types of main video inputs such as Ypbpr 1080i, VGA 800*600 and VGA 1920*1200, are shown in Table 1.

TABLE 2
(sub path)

| Panel 1920 * 1080 | | TV decoder | NR | Deinterlace | Scalar down | Scalar up |
|---|---|---|---|---|---|---|
| TV | 480i/576i | (Nt2 + Nt3) * 1135 * 10 | Nsn * 720 * 10 | Nsd * 720 * 10 | 0 | Mssu * 720 * 10 |
| YPbPr | 1080i | 0 | Nsn * 960 * 10 | Nsd * 960 * 10 | 0 | 0 |
| VGA | 800 * 600 | 0 | Nsn * 800 * 10 | 0 | 0 | Mssu * 800 * 10 |
| VGA | 1920 * 1200 | 0 | Nsn * 960 * 10 | 0 | Nssd * 960 * 10 | 0 |

Table 2 shows SRAM sizes required for processing different types of sub video input through different post-processing stages to be displayed on a display panel with 1920*1080 pixels. For example, if the sub video input is a 480i/576i video signal, the TV decoder 220 requires an SRAM size of (Nt2+Nt3)*1135*10 bits, the noise reduction unit 242 requires an SRAM size of Nsn*720*10 bits, the deinterlace unit 252 requires an SRAM size of Nsd*720*10 bits, the scalar down unit 262 did not require any SRAM because the image size of the 480i/576i video signal is smaller than that of the panel resolution (1440*768), and the scalar up unit 272 requires an SRAM size of Nssu*720*10 bits. Similar notations are used in Table 1 and Table 2, where “s” in Nsn, Nsd, Nssd, Nssu denotes sub path. The rest of Table 2 illustrates the SRAM sizes required for some other types of sub video input such as Ypbpr 1080i, VGA 800*600 and VGA 1920*1200.

Since the size of the maximum second images (sub path) is assumed as a quarter of the entire display panel area, the length of the maximum second image is half length of the maximum panel resolution, 1920/2=960. Therefore, if the sub video input is YPbPr or VGA 1920*1200, the noise reduction unit 242 only requires an SRAM size of Nsn*960*10 bits, not Nsn*1920*10 bits.

The above parameters Nt2, Nt3, Nmn, Nmd, Nmsd, Nmsu, Nsn, Nsd, Nssd and Nssu are positive integers. In the following embodiments, it is assumed that Nt2=4, Nt3=6, Nmn=4, Nmd=8, Nmsd=3, Nmsu=9, Nsn=4, Nsd=8, Nssd=3 and Nssu=3.

TABLE 3
(Case 1) Panel 1440, Main: TV, Sub: YPbPr

| Panel 1440 * 768 | | | TV decoder | NR | Deinterlace | Scalar down | Scalar up |
|---|---|---|---|---|---|---|---|
| (A) Main | TV | 480i/576i | 10 * 1135 * 10 | 4 * 720 * 10 | 8 * 720 * 10 | 0 | 9 * 720 * 10 |
| (B) Sub | YPbPr | 480i/576i | 0 | 4 * 720 * 10 | 8 * 720 * 10 | 0 | 3 * 720 * 10 |
| (C) Sub | YPbPr | 720i | 0 | 4 * 720 * 10 | 8 * 720 * 10 | 0 | 3 * 720 * 10 |
| (D) Sub | YPbPr | 1080i | 0 | 4 * 720 * 10 | 8 * 720 * 10 | 3 * 720 * 10 | 0 |

Table 3 shows that the display panel is 1440*768 pixels, the main path processes a 480i/576i TV signal and the sub path processes a Ypbpr signal with 480i/576i, 720i or 1080i resolution. The maximum SRAM size required is 10*1135*10+42*360*10 bits (main path)+30*360*10 bits (sub path). In this embodiment, the SRAM pool is composed of SRAM units with two different sizes, 1135*10 bits and 360*10 bits. In some other embodiments, the SRAM unit size of 720*10 bits can be used instead of 360*10 bits, or the SRAM pool comprises both 720*10 bits and 360*10 bits.

Table 4 shows that the display panel is a 1920*1080 panel, the main path processes a 480i/576i TV signal and the sub path processes a Ypbpr signal with 480i/576i, 720i or 1080i resolution. The maximum SRAM size required is the summation of (E) and (G), which is 10*1135*10+42*360*10 bits (main path)+45*320*10 bits (sub path). In this embodiment, three sizes of SRAM units, 1135*10 bits, 360*10 bits, and 320*10 bits are shared by various processing units for processing the main video and sub video inputs.

TABLE 4
(Case 2) Panel 1920, Main: TV, Sub: YPbPr

| Panel 1920 * 1080 | | | TV decoder | NR | Deinterlace | Scalar down | Scalar up |
|---|---|---|---|---|---|---|---|
| (E) Main | TV | 480i/576i | 10 * 1135 * 10 | 4 * 720 * 10 | 8 * 720 * 10 | 0 | 9 * 720 * 10 |
| (F) Sub | YPbPr | 480i/576i | 0 | 4 * 720 * 10 | 8 * 720 * 10 | 0 | 3 * 720 * 10 |
| (G) Sub | YPbPr | 720i | 0 | 4 * 960 * 10 | 8 * 960 * 10 | 0 | 3 * 960 * 10 |
| (H) Sub | YPbPr | 1080i | 0 | 4 * 960 * 10 | 8 * 960 * 10 | 0 | 0 |

Table 5 shows that the display panel is a 1440*768 panel, the sub path processes a 480i/576i TV signal and the main path processes a Ypbpr signal with 480i/576i, 720i or 1080i resolution. The maximum SRAM size required is the summation of (K) and (L), which is 72*320*10+12*360*10 bits (main path)+10*1135*10+30*360*10 bits (sub path).

TABLE 5
(Case 3) Panel 1440, Main: YPbPr, Sub: TV

| Panel 1440 * 768 | | | TV decoder | NR | Deinterlace | Scalar down | Scalar up |
|---|---|---|---|---|---|---|---|
| (I) Main | YPbPr | 480i/576i | 0 | 4 * 720 * 10 | 8 * 720 * 10 | 0 | 9 * 720 * 10 |
| (J) Main | YPbPr | 720i | 0 | 4 * 1280 * 10 | 8 * 1280 * 10 | 0 | 9 * 1280 * 10 |
| (K) Main | YPbPr | 1080i | 0 | 4 * 1920 * 10 | 8 * 1920 * 10 | 3 * 1440 * 10 | 0 |
| (L) Sub | TV | 480i/576i | 10 * 1135 * 10 | 4 * 720 * 10 | 8 * 720 * 10 | 0 | 3 * 720 * 10 |

Table 6 shows that the display panel is a 1920*1080 panel, the sub path processes a 480i/576i TV signal and the main path processes a Ypbpr signal with 480i/576i, 720i or 1080i resolution. The maximum SRAM size required is the summation of (N) and (P), which is 84*320*10 bits (main path)+10*1135*10+30*360*10 bits (sub path).

TABLE 6
(Case 4) Panel 1920, Main: YPbPr, Sub: TV

| Panel 1920 * 1080 | | | TV decoder | NR | Deinterlace | Scalar down | Scalar up |
|---|---|---|---|---|---|---|---|
| (M) Main | YPbPr | 480i/576i | 0 | 4 * 720 * 10 | 8 * 720 * 10 | 0 | 9 * 720 * 10 |
| (N) Main | YPbPr | 720i | 0 | 4 * 1280 * 10 | 8 * 1280 * 10 | 0 | 9 * 1280 * 10 |
| (O) Main | YPbPr | 1080i | 0 | 4 * 1920 * 10 | 8 * 1920 * 10 | 0 | 0 |
| (P) Sub | TV | 480i/576i | 10 * 1135 * 10 | 4 * 720 * 10 | 8 * 720 * 10 | 0 | 3 * 720 * 10 |

Table 7 shows that the display panel is a 1440*768 panel, the main path processes a YPbPr signal with 720i or 1080i resolution and the sub path also processes a Ypbpr signal with the 720i or 1080i resolution. The maximum SRAM size required is the summation of (S) and (T) or (S) and (U), which is 72*320*10+12*360*10 bits (main path)+30*360*10 bits (sub path).

TABLE 7
(Case 5) Panel 1440, Main: YPbPr, Sub: YPbPr

| Panel 1440 * 768 | | | TV decoder | NR | Deinterlace | Scalar down | Scalar up |
|---|---|---|---|---|---|---|---|
| (R) Main | YPbPr | 720i | 0 | 4 * 1280 * 10 | 8 * 1280 * 10 | 0 | 9 * 1280 * 10 |
| (S) Main | YPbPr | 1080i | 0 | 4 * 1920 * 10 | 8 * 1920 * 10 | 3 * 1440 * 10 | 0 |
| (T) Sub | YPbPr | 720i | 0 | 4 * 720 * 10 | 8 * 720 * 10 | 0 | 3 * 720 * 10 |
| (U) Sub | YPbPr | 1080i | 0 | 4 * 720 * 10 | 8 * 720 * 10 | 3 * 720 * 10 | 0 |

Table 8 shows that the display panel is a 1920*1080 panel, the main path processes a YPbPr signal with 720i or 1080i resolution and the sub path processes a Ypbpr signal with 720i or 1080i resolution. The maximum SRAM size required is the summation of (W) and (Y), which is 84*320*10 bits (main path)+45*320*10 bits (sub path).

TABLE 8
(Case 6) Panel 1920, Main: YPbPr, Sub: YPbPr

| Panel 1920 * 1080 | | | TV decoder | NR | Deinterlace | Scalar down | Scalar up |
|---|---|---|---|---|---|---|---|
| (W) Main | YPbPr | 720i | 0 | 4 * 1280 * 10 | 8 * 1280 * 10 | 0 | 9 * 1280 * 10 |
| (X) Main | YPbPr | 1080i | 0 | 4 * 1920 * 10 | 8 * 1920 * 10 | 0 | 0 |
| (Y) Sub | YPbPr | 720i | 0 | 4 * 960 * 10 | 8 * 960 * 10 | 0 | 3 * 960 * 10 |
| (Z) Sub | YPbPr | 1080i | 0 | 4 * 960 * 10 | 8 * 960 * 10 | 0 | 0 |

As seen in Tables 1˜8, not all processing units are operated at the same time. For example, the scalar up unit and the scalar down unit are typically not operated at the same time. The deinterlace unit is not enabled for progressive signals, such as the VGA signal 800*600 or 1920*1200. The TV decoder is not enabled if the processed signal is not a TV signal. Thus, the SRAM pool 210 of the video system comprises SRAM units with various sizes are shared by different processing units to reduce the required memory size. According to an embodiment of the invention, one size of the SRAM unit is a common factor of SRAM size required for two or more processing units. In addition, small size SRAM units are easily shared between a plurality of processing units, however, control of small size SRAM units is more complicated than control of large size SRAM units.

Table 9 shows an exemplary arrangement of the SRAM pool 210 according to the above Cases 1˜6 corresponding to Tables 3˜8 respectively. There are three sizes of SRAM units, 360*10 bits units, 320*10 bits units and 1135*10 bits units in this embodiment. Some of the SRAM units allocated to a processing unit are not exactly equal to the amount of SRAM required, for example, SRAM units of 360*10 are used for applications which need SRAM units of 320*10. According to the arrangement in Table 9, the minimum size of the SRAM pool 210 is 42*360*10+72*320*10+10*1135*10 bits, which is 495100 bits. The SRAM pool 210 can be shared by the TV decoder (TV) 220, noise reduction units (NR) 241 and 242, deinterlace units (DI) 251 and 252, scalar up units (SU) 261 and 262, and scalar down units (SD) 271 and 272. The SRAM size for a main video input of YPbPr 1080i and a sub video input of TV 480i/576i can be expressed as (Nt2+Nt3)*1135*10+(Nmn+Nmd)*1920*10+Nmsd*1440*10+(Nsn+Nsd+Nssu)*720*10. Compared to the dedicated SRAM implementation, the total SRAM needed can be expressed as (Nt2+Nt3)*1135*10+(Nmn+Nmd+Nmsd+Nmsu)*1920*10+(Nsn+Nsd+Nssd+Nssu)*10. The size of SRAM saved by using the SRAM pool is Nmsd*480*10+Nmsu*1920*10+Nssd*960*10+(Nsn+Nsd+Nssu)*240*10, which is 25200 bits if substituting the numerical assumptions used in the previous embodiments. This reduction of SRAM size significant since 25200 bits is approximately one third of the original SRAM size required.

TABLE 9

| 360 * 10 | | | | | 320 * 10 | | | | |
|---|---|---|---|---|---|---|---|---|---|
| 8 | 1 | 15 | 12 | 6 | 16 | 32 | 16 | 2 | 6 |

| | | | | | | |
|---|---|---|---|---|---|---|
| Case 1, 2 | NR | DI | SU, SD | NR | DI | SU, SD |

| | | | | | | | |
|---|---|---|---|---|---|---|---|
| Case 3, 4, 5 | NR | DI | SU, SD | SU, SD | NR | DI | SU, SD |

| | |
|---|---|
| DI | NR |

| | | | | | | | |
|---|---|---|---|---|---|---|---|
| Case 6 | NR | DI | SU, SD | SU, SD | NR | DI | SU, SD |

| | |
|---|---|
| DI | NR |

1135 * 10

| | | | |
|---|---|---|---|
| 1 | 3 | 1 | 5 |

| | |
|---|---|
| Case 1, 2 | TV |
| Case 3, 4 | TV |
| Case 5 | |

| | | | |
|---|---|---|---|
| Case 6 | NR | DI | SU, SD |

The size of the SRAM pool can be designed to be a maximum amount of memory required at a time by a plurality of processing units that share the SRAM pool, or it can be designed to be slightly larger than this maximum value. The number of processing units that share the SRAM pool and which processing units share the SRAM pool should not be limitations to the invention, sharing the SRAM pool by two processing units can even gain some advantage of SRAM size and cost reduction.

While the invention has been described by way of example and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An memory sharing method for a video system, comprising
determining a type of an input video signal;
sharing an SRAM (static random access memory) pool among at least two different processing units of the video system, wherein the SRAM pool comprises a plurality of SRAM units having different sizes, and an SRAM unit size is determined as a common factor of memory sizes required by at least two processing units; and
allocating a combination of SRAM units in the SRAM pool to each processing unit processing the input video signal according to the type of the input video signal.

2. The memory sharing method as claimed in claim 1, wherein the processing units comprise a TV decoder, a noise reduction unit, a deinterlace unit, a scalar down unit and a scalar up unit.

3. The memory sharing method as claimed in claim 1, wherein the memory size required by a processing unit is determined by the type of the input video signal.

4. The memory sharing method as claimed in claim 1, wherein the sizes of the SRAM units of the SRAM pool are determined by types of the input video signal that can be processed by the video system.

5. The memory sharing method as claimed in claim 1, wherein the input video signal comprises a main input video signal and a sub input video signal for picture in picture (PIP) applications.

6. The memory sharing method as claimed in claim 1, wherein allocating a combination of SRAM units to each processing unit further comprises allocating the same SRAM units to a scaler down unit and a scaler up unit.

7. The memory sharing method as claimed in claim 1, further comprising:
processing a main video signal of the input video signal by a set of processing units and processing a sub video signal of the input video signal by another set of processing units; and
blending processed main video signal and processed sub video signal for output display.

8. The memory sharing method as claimed in claim 1, wherein an SRAM unit in the SRAM pool used by a first processing unit is accessed by a second processing unit when the input video signal is switched to a different type.

9. A video system, comprising:
a plurality of processing units;
an SRAM pool comprising a plurality of SRAM units having different sizes for sharing among at least two different processing units, wherein an SRAM unit size is determined as a common factor of memory sizes required by at least two processing units; and
a controller determining a type of an input video signal, and allocating a combination of SRAM units to each processing unit processing the input video signal according to the type of the input video signal.

10. The video system as claimed in claim 9, wherein the processing units comprise a TV decoder, a noise reduction unit, a deinterlace unit, a scalar down unit and a scalar up unit.

11. The video system as claimed in claim 9, wherein the memory size required by a processing unit is determined by the type of the input video signal.

12. The video system as claimed in claim 9, wherein the sizes of the SRAM units of the SRAM pool are determined by types of the input video signal that can be processed by the video system.

13. The video system as claimed in claim 9, wherein the input video signal comprise a main input video signal and a sub input video signal for picture in picture (PIP) applications.

14. The video system as claimed in claim 9, wherein the controller allocates the same SRAM units to a scaler down unit and a scaler up unit.

15. The video system as claimed in claim 9, further comprising a source selection unit for receiving and selecting input video signals to output to the processing units.

16. The video system as claimed in claim 9, wherein the processing units comprises two sets of processing units, one set of processing units processes a main video signal of the input video signal and another set processes a sub video signal of the input video signal, and the video system further comprises:
a mixer blending processed main video signal and processed sub video signal for output display.

17. The video system as claimed in claim 9, wherein an SRAM unit in the SRAM pool used by a first processing unit is accessed by a second processing unit when the input video signal is switched to a different type.

18. A video system, comprising:
a main source selection unit for receiving and selecting input video signals for a main path;
a sub source selection unit for receiving and selecting input video signals for a sub path;
a plurality of processing units, a set of the processing units processes the input video signal of the main path, and another set processes the input video signal of the sub path;
an SRAM pool comprising a plurality of SRAM units having different sizes for sharing among at least two different processing units, wherein an SRAM unit size is determined as a common factor of memory sizes required by at least two processing units;
a controller determining a type of the input video signal selected by the main source selection unit and the sub source selection unit, and allocating a combination of SRAM units to each processing unit processing the input video signal of the main path or sub path according to the type of the input video signal processed in the main path or sub path; and
a mixer blending processed main video signal and processed sub video signal for output display.

19. The video system as claimed in claim 18, further comprising a TV decoder, decoding a TV signal to output the input video signal for the main source selection unit or the sub source selection unit.

20. The video system as claimed in claim 18, wherein an SRAM unit in the SRAM pool used by a first processing unit is accessed by a second processing unit when the input video signal is switched to a different type.
